(19) United States
(12) Patent Application Publication
(10) Pub. No.: US 2008/0289857 A1
(43) Pub. Date: Nov. 27, 2008

(54) High-Voltage Insulator and Cooling Element with this High-Voltage Insulator

(75) Inventors: Jean-Claude Mauroux, Hunzenschwil (CH); Martin Lakner, Gebenstorf (CH); Leopold Ritzer, Untersiggenthal (CH); Reto Wedder, Habsburg (CH)

Correspondence Address: BUCHANAN, INGERSOLL & ROONEY PC, POST OFFICE BOX 1404, ALEXANDRIA, VA, 22313-1404, US

(73) Assignee: ABB TECHNOLOGY AG, Zurich (CH)

(21) Appl. No.: 12/123,126

(22) Filed: May 19, 2008

(30) Foreign Application Priority Data
May 23, 2007 (EP) 07108754.8

(51) Int. Cl. H01B 17/00; B32B 37/00

(52) U.S. Cl. 174/158 R; 156/293

(57) ABSTRACT

A high-voltage insulator contains, in a coaxial arrangement: an insulating tube with an end in the form of a bearing ring, a hollow metal armature held on the bearing ring, an adhesive-bonding joint, which is provided between an adhesive-bonding area of the bearing ring and an adhesive-bonding area of the metal armature and is filled in a vacuum-tight manner with a cured adhesive layer, and a cavity, which is extended along the axis of the insulating tube and is radially delimited by the insulating tube and the metal armature. At least one predominantly radially guided adhesive channel is arranged between the cavity and the adhesive-bonding joint, which adhesive channel is sealed with cured adhesive and has a cross section which is sufficient for guiding uncured adhesive from the cavity into the adhesive-bonding joint prior to the formation of the cured adhesive layer.

### RELATED APPLICATION

This application claims priority under 35 U.S.C. §119 to European Patent Application No. 07108754.8 filed in Europe on May 23, 2007, the entire content of which is hereby incorporated by reference in its entirety.

### TECHNICAL FIELD

The present disclosure relates to a high-voltage insulator, a method for producing said insulator, and an apparatus for implementing the method and to a cooling element with said high-voltage insulator. The high-voltage insulator contains, in a coaxial arrangement, at least one insulating tube with an end in the form of a bearing ring, a hollow metal armature held on the bearing ring, an adhesive-bonding joint, which is provided between an adhesive-bonding area of the bearing ring and an adhesive-bonding area of the metal armature and is filled in a vacuum-tight manner with a cured adhesive layer, and a cavity, which is extended along the axis of the insulating tube and is radially delimited by the insulating tube and the metal armature. In general, with this high-voltage insulator the other end of the insulating tube which is remote from the bearing ring is likewise in the form of a bearing ring and is connected to a further metal armature via an adhesive-bonding joint.

### BACKGROUND INFORMATION

Such an insulator can be used as an insulating section in the case of passive cooling of a high-voltage device conducting high currents, where high voltage is in principle understood to mean an operating voltage of greater than 1 kV. The preferred voltage range is below 100 kV, however, and primarily relates to high-current-conducting apparatuses and installations with rated voltages of typically from 10 to 50 kV.

The current-carrying capacity of such apparatuses and installations is thermally limited. For rated currents in the range of typically from 10 to 50 kA, as are conducted, for example, in heavy-duty devices in the form of generator circuit breakers, active cooling elements (for example air/air heat exchangers with fans) or passive cooling elements with particularly good efficiency are therefore especially used, such as in particular heat pipes, which, in addition to the high-voltage insulator defined at the outset, also contain an evaporator and a heat exchanger as well as a working medium. Heat produced as a result of current losses in the heavy-duty device is in this case used for evaporating the working medium. The evaporated working medium is transported to an externally arranged heat exchanger and again emits the lost heat formed in the heavy-duty device as a result of condensation there.

Heavy-duty devices in the form of generator circuit breakers generally have a single-phase encapsulated design and have an inner conductor, which is arranged in the encapsulation and is at a high voltage potential. Heat formed as a result of current losses on the inner conductor needs to be dissipated through the encapsulation to the ambient air. This means that an electrically insulating path needs to be located between an evaporator which is at high voltage potential and a condenser of the heat pipe which is kept at ground potential, which electrically insulating path needs to be designed corresponding to the required high voltage (for example 150 kV BIL). The evaporator and the heat exchanger (condenser) are held in a vacuum-tight manner at both ends of the high-voltage insulator.

Since there are no longer any moving parts, such as fans or blowers, in the case of such a high-power, passive cooling element, the lost heat can be removed from the encapsulation inexpensively and efficiently using this cooling element. In addition, such a cooling element does not require any maintenance. The high-voltage insulator in this case fulfils a plurality of functions, primarily that of guiding the working medium and that of isolating the potentials of the evaporator and the condenser. The reliability of such a high-power passive cooling element and a high-voltage installation equipped with such a cooling element is only ensured when the insulator performs the abovementioned functions over many years. Such an insulator should therefore not require any maintenance for a long period of time, typically 20 years. Such a high long-term stability presupposes an extremely low leakage rate since only in this way is it possible to avoid a loss of working medium.

A high-voltage insulator of the abovementioned type is described in WO 2006/053552 A1. This insulator is part of a hollow cooling element, which is in the form of a heat pipe and is used for dissipating heat from an outgoing generator line. It has, in a coaxial arrangement, a mechanically supporting insulating tube made of a fiber-reinforced polymer and of coaxially held diffusion barriers as well as two hollow metal armatures, which are adhesively bonded in a vacuum-tight manner to the two ends, which are each in the form of a bearing ring, of the insulating tube. An adhesive-bonding joint, which is extended from the end side of each bearing ring onto its lateral surface and is filled in a vacuum-tight manner with a cured adhesive layer, is provided between an adhesive-bonding area of each of the two bearing rings and an adhesive-bonding area of each of the two metal armatures.

An evaporator, which is kept at the potential of a high-voltage conductor, is fixed on one of the two metal armatures, and a condenser, which is kept at the potential of a grounded encapsulation, is fixed on the other armature. The high-voltage insulator forms an insulating path of a cooling element, which transfers heat formed by current losses in the high-voltage conductor to the encapsulation. In this case, a working medium, for example in particular acetone or a hydrofluoroether, which is located in the interior of the cooling element, is used for the heat transfer and in this case circulates in the form of vapor from the evaporator through the insulating tube to the condenser, in which the vapor condenses whilst emitting the heat as a liquid. The liquid is passed back through the high-voltage insulator again to the evaporator. The high-voltage insulator therefore serves not only as an insulating path, but also as a line for the working medium. Since this line accommodates a chemical medium, is subjected to a permanent temperature of typically 80° C. and needs to be liquid-tight, gas-tight and vacuum-tight over many, typically 20, years, stringent requirements are placed on the adhesive joints between the two ends of the insulating tube, which are each in the form of a bearing ring, and the metal armatures.

### SUMMARY

Exemplary embodiments disclosed herein can provide a high-voltage insulator of the type mentioned at the outset which has a low leakage rate and is also characterized by a high degree of operational reliability after operation for many years under severe mechanical, electrical, thermal and chemical loading, and can provide a method for producing said high-voltage insulator, an apparatus for implementing said method and a cooling element containing said insulator.

A high-voltage insulator is disclosed, containing, in a coaxial arrangement: an insulating tube with an end in the form of a bearing ring, a hollow metal armature held on the bearing ring, an adhesive-bonding joint, which is provided between an adhesive-bonding area of the bearing ring and an adhesive-bonding area of the metal armature and is filled in a vacuum-tight manner with a cured adhesive layer, and a cavity, which is extended along the axis of the insulating tube and is radially delimited by the insulating tube and the metal armature, wherein at least one predominantly radially guided adhesive channel is arranged between the cavity and the adhesive-bonding joint, which adhesive channel is sealed with cured adhesive and has a cross section which is sufficient for guiding uncured adhesive from the cavity into the adhesive-bonding joint prior to the formation of the cured adhesive layer.

Further features and further advantageous effects of the disclosure result from the exemplary embodiment described below.

### BRIEF DESCRIPTION OF THE DRAWINGS

This exemplary embodiment of the disclosure is explained in more detail with reference to the drawings, in which:

FIG. 1 shows a side view of an exemplary apparatus, in which precisely one high-voltage insulator according to the disclosure is produced,

FIG. 2 shows a perspective illustration of an insulating tube of the high-voltage insulator shown in FIG. 1,

FIG. 3 shows an enlarged illustration of an end section III in the form of a bearing ring of the insulating tube shown in FIG. 2,

FIG. 4 shows a plan view of a section along an axis A through the lower end section of the high-voltage insulator shown in FIG. 1 when adhesive is injected into an adhesive-bonding joint arranged between a bearing ring of an insulating tube of the high-voltage insulator and a metal armature,

FIG. 5 shows the plan view shown in FIG. 4 after the injection of the adhesive, and

FIG. 6 shows the plan view shown in FIG. 4 after the removal of part of the exemplary apparatus, which is in the form of an injection aid, for producing the high-voltage insulator.

### DETAILED DESCRIPTION

In the case of the high-voltage insulator according to the disclosure, at least one predominantly radially guided adhesive channel is arranged between the cavity and the adhesive-bonding joint, which adhesive channel is sealed with cured adhesive and has a cross section which is sufficient for guiding uncured adhesive from the cavity into the adhesive-bonding joint prior to the formation of the cured adhesive layer. Since, before it cures, the adhesive is guided out of the cavity via the adhesive channel into the adhesive-bonding joint, a particularly homogeneous adhesive layer which is kept free of undesirable air inclusions can therefore be achieved using simple means and in a comparatively short amount of time between two parts to be joined, i.e. between a bearing ring of an insulating tube and a metal armature. Since the adhesive-bonding areas of the two parts to be joined are 100% covered with cured adhesive and the entire adhesive-bonding joint is completely filled with cured adhesive, the high-voltage insulator according to the disclosure and a cooling element containing this high-voltage insulator are characterized by a very low leakage rate and by excellent dielectric behavior, such as in particular high resistance to leakage currents. The high-voltage insulator and the cooling element according to the disclosure correspondingly have a high long-term stability.

In an exemplary method which is particularly suitable for producing the high-voltage insulator, the insulating tube and the metal armature are joined so as to form the adhesive-bonding joint and the cavity, an injection aid containing liquid adhesive is installed in the cavity, and the liquid adhesive is pressurized, using the injection aid, in a section of the cavity which is in the form of a compression space and is injected out of the compression space, via the at least one adhesive channel, into the adhesive-bonding joint. In this method, the adhesive is introduced into the adhesive-bonding joint without any air bubbles and in such a way that it is well distributed and therefore a vacuum-tight adhesive-bonding joint is achieved in a reliable and easily reproducible manner. With this method, vacuum-tight high-voltage insulators with a low leakage rate and a long life can therefore be manufactured virtually without any rejects.

In an exemplary apparatus for implementing this method, the injection aid is in the form of a piston/cylinder compression apparatus and has a compression space, which is designed to be suitable for accommodating the liquid adhesive and is delimited radially on the outside by the bearing ring and axially by a cylinder base, which is fixed in the metal armature, and a piston, which is axially displaceable in the bearing ring. The piston/cylinder compression apparatus can easily be incorporated in the manufacturing process and ensures that undesired air is forced out of the adhesive-bonding joint and the adhesive-bonding joint is filled completely with adhesive without any air bubbles.

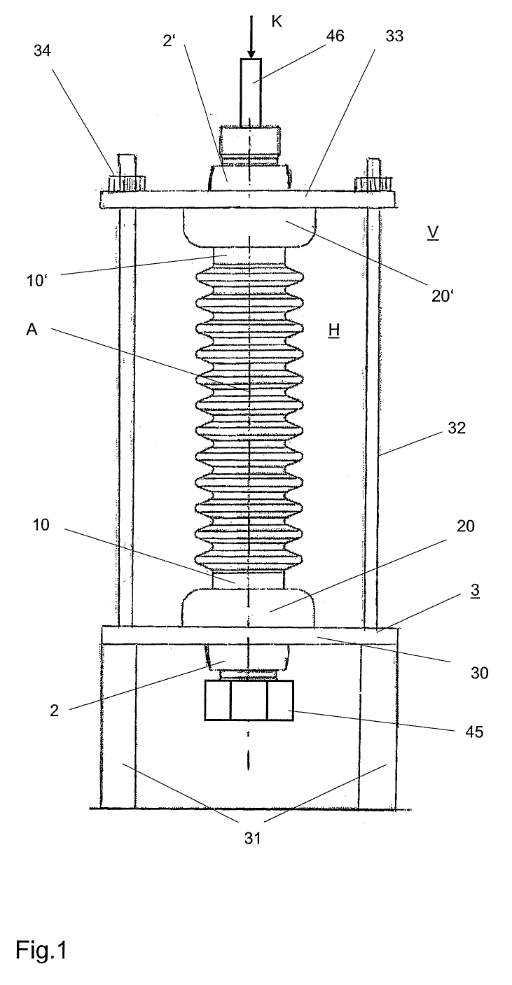

In all of the figures, the same reference numerals denote functionally identical parts. A high-voltage insulator H which is designed to be axially symmetrical and is shown in FIG. 1 is arranged in such a way that it is aligned along its axis of symmetry A in a clamping apparatus 3 of an apparatus V for its production. The high-voltage insulator contains an insulating tube 1, whose two ends are each in the form of a bearing ring 10, 10′, and two hollow metal armatures 2 and 2′. The insulating tube 1 is manufactured from a polymeric composite, for example on the basis of a duromer, such as an epoxide, for example, and a filler, such as quartz powder or glass fibers, for example, but can also be produced from a ceramic, such as porcelain, for example. In the coaxial arrangement, the metal armature 2 is adhesively bonded in a vacuum-tight manner to the bearing ring 10, and the metal armature 2′ to the bearing ring 10′. A horizontally aligned base plate 30 of the clamping apparatus 3 is supported on spacer feet 31, and the clamping apparatus 3 has two vertically aligned threaded rods 32, which are fixed rigidly to the base plate 30. An opening (not visible) is provided in the base plate, through which opening the lower part of the metal armature 2 is guided. A part of the metal armature 2 which is in the form of a field electrode 20 rests on the base plate 30. The metal armature 2′ has the same design as the metal armature 2 and contains a field electrode 20′, on which a pressure bar 33 rests. A part of the armature 2′ which corresponds to the lower part of the armature 2 is guided through a likewise not visible opening through the pressure bar 33. The pressure bar 33 is pressed against the field electrode 20′ by means of two pressure nuts 34, which are guided on the threaded rods 32, and therefore fixes the high-voltage insulator H in the clamping apparatus 3.

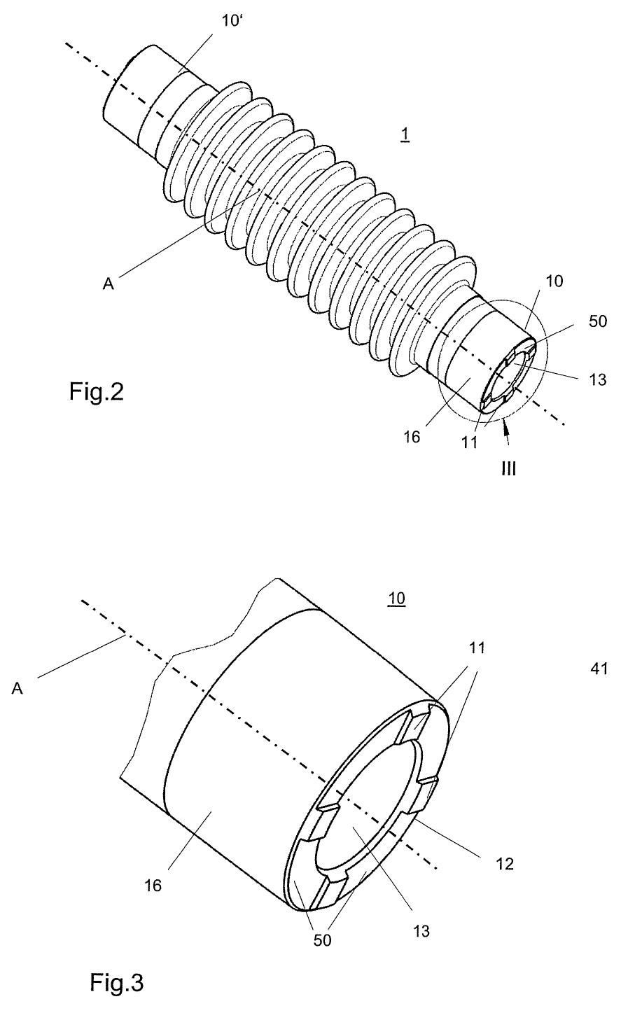

The two bearing rings 10, 10′ are of identical design and have spacer cams 11 (illustrated in FIGS. 2 and 3 in the case of the bearing ring 10), which are formed into the free end side 12 of the bearing ring 10 and are aligned axially. In each case two of the spacer cams 11 delimit a predominantly radially guided adhesive channel 50 in the circumferential direction of the end side 12. As can be seen, the four spacer cams 11, which are visible from the exemplary embodiment illustrated, delimit four predominantly radially aligned adhesive channels 50 which are arranged uniformly distributed in the circumferential direction (in relation to the axis A).

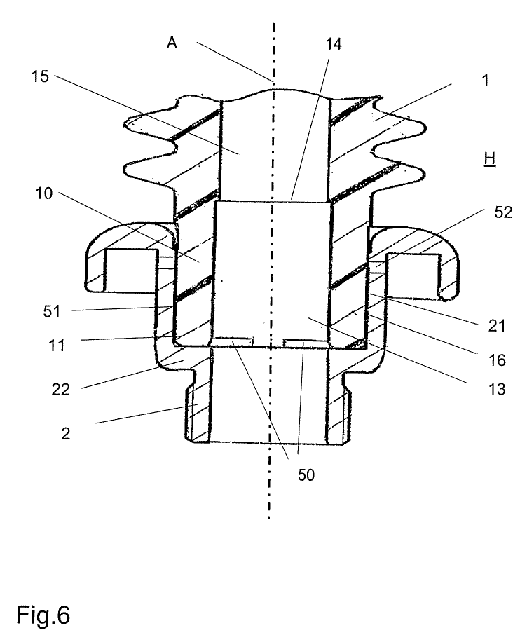

A cylindrical sealing face 13 is formed into the inner side of the bearing ring 10. As can be seen from FIG. 6, this sealing face surrounds a section of a cavity 15 which is radially delimited by the bearing ring 10, is extended axially between the adhesive channels 50 and a stop 14 and is surrounded by the insulator H or the insulating tube 1 and the two metal armatures 2, 2′.

An adhesive-bonding area 16 (shown in FIGS. 2 and 3) is formed into the outer side of the bearing ring 10. As is illustrated in FIG. 6, an adhesive-bonding joint 51, which is filled in a vacuum-tight manner with a cured adhesive layer, is provided between this adhesive-bonding area and an adhesive-bonding area 21 of the metal armature 2. The adhesive channels 50, which run between the cavity 15 and the adhesive-bonding joint 51, are also sealed in a vacuum-tight manner with cured adhesive. The adhesive-bonding joint 51 is connected to a plurality of ventilation openings 52, which are distributed uniformly in the circumferential direction and are guided above the adhesive-bonding area 21 predominantly radially on the outside through the metal armature 2. The adhesive-bonding joint 51 is dimensioned in such a way that its cross section decreases between the adhesive channels 50 and the ventilation openings 52. An adhesive-bonding joint 51 with such dimensions can be produced by conically beveling the adhesive-bonding area 16. The conical adhesive-bonding area 16 widens in the axial direction between the adhesive channels 50 and the ventilation openings 52 and can easily be formed into the bearing ring 10 when the insulating tube 1 is manufactured, for example when the insulating tube is cast and/or by metal-cutting of a precursor body of the insulating tube.

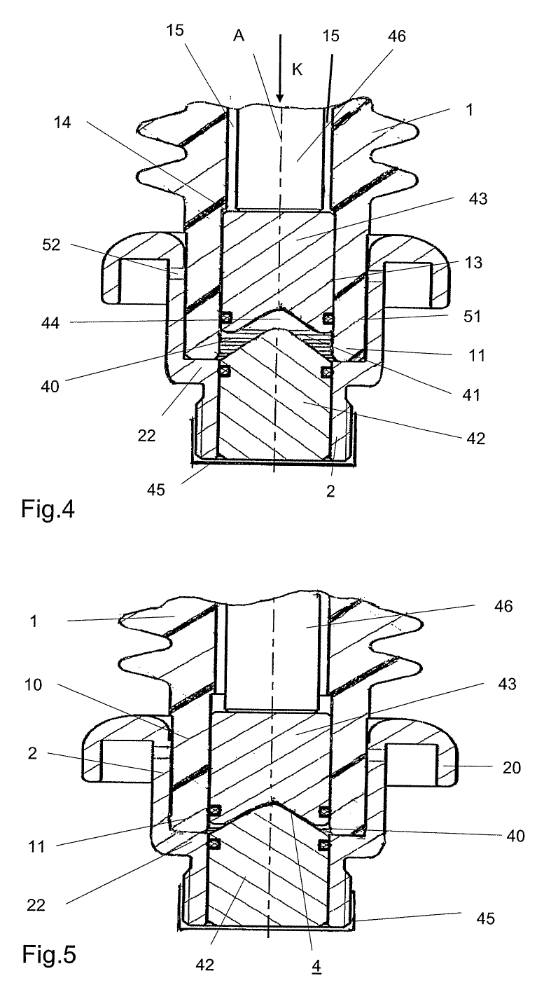

In order to manufacture the high-voltage insulator H, the insulating tube 1 and the metal armature 2 are joined so as to form the adhesive-bonding joint 51. In order in the process to achieve a good press fit, the metal armature 2 is heated, typically to approximately 150° C., and the heated metal armature 2 is drawn onto the bearing ring 10 until the spacer cams 11 rest on a shoulder 22, which is guided radially on the inside, of the metal armature 2 (FIGS. 4 to 6). In a corresponding manner, the metal armature 2′ and the bearing ring 10′ are also joined, although these two parts can also be connected to one another by screwing using sealing rings or by means of encapsulation by casting. In any case, an axially extended cavity 15, which is axially delimited by the insulating tube 1 and the two hollow metal armatures 2, 2′, is thus formed.

As can be seen in FIGS. 4 and 5, an injection aid 4 containing liquid adhesive 40 is installed in the cavity 15. This injection aid is in the form of a piston/cylinder compression apparatus and comprises a compression space 41 (FIG. 4), which accommodates the liquid (uncured) adhesive 40 and is delimited radially on the outside by the bearing ring 10 and the shoulder 22 of the metal armature 2 and axially by a cylinder base 42, which is fixed in the metal armature 10, and a piston 43, which is axially displaceable in the bearing ring 10. The cylinder base 42 and the piston 43 in each case bear at least one sealing ring (not designated for reasons of clarity) on their lateral surfaces. The sealing ring borne by the cylinder base 42 rests in a gas-tight manner on a cylinder-symmetrical inner face of the metal armature 2 in the region of the shoulder 22, whereas the sealing ring of the piston 43, which can be displaced in the axial direction between the stop 14 and the cylinder base 42, is mounted in a gas-tight and liquid-tight manner on the sealing face 13.

During the installation of the injection aid 3, the insulating tube 1 and the metal armatures 2, 2′ are initially held in such a way that the metal armature 2 points upwards. The piston 43 is now introduced through the metal armature 2 into the cavity 15 and held on the stop 14. As can be seen, a conical depression 44, which is formed in the manner of a funnel, for accommodating the liquid adhesive 40 is formed into a side of the piston 43 which delimits the compression space 41. A metered amount of liquid adhesive, for example a two-component adhesive based on an epoxide, is already provided in this depression. Then, the cylinder base 42 is also pushed into the cavity 15 from above. The piston base 42 is secured against falling out by means of a closure nut 45 shown in FIGS. 1, 4 and 5. Then, the entire arrangement is rotated downwards and therefore the position of the arrangement shown in FIG. 4 is reached, in which position the injection aid 4 has a compression space 41, which extends in the axial direction from the sealing face 13 via inlets of the adhesive channels 50 as far as the inner face of the metal armature 2 in the region of the shoulder 22.

As can be seen in FIG. 1, the exemplary arrangement is fixed in the clamping apparatus 3 and a plunger 46 is pushed into the cavity 15 from above through the metal armature 2′. This plunger is supported on the piston 43 on the side remote from the compression space 41 (FIG. 4). If an axially downwardly directed force K now acts, as shown in FIG. 4, on the plunger 46, the piston 43 is guided downwards and in the process increases the pressure of the liquid adhesive 40 in the compression space 41. A displacement of the metal armature 2 under the effect of the hydraulic force occurring in the process is prevented by the clamping apparatus 3. The liquid adhesive 40 is injected into the adhesive-bonding joint 51 via the adhesive channels 50. The adhesive channels 50 are dimensioned in such a way that a sufficient quantity of uncured adhesive 40 is guided from the compression space 41 into the adhesive-bonding joint 51 prior to the formation of the cured adhesive layer. The adhesive 40 supplied compresses the air in the adhesive-bonding joint 51 and fills up the adhesive-bonding joint 51 as far as the ventilation openings 52. Excess adhesive 40 escapes at the ventilation openings 52. Once the closure nuts 45 have been removed, the injection aid 4 and the plunger 46 can then be removed from the cavity 15 and the adhesive-bonding point can be cured at elevated temperature, typically from 60 to 80° C. The leakage rate of this adhesive-bonding point is typically less than 10⁻⁹ [mbar I/s].

A particularly good distribution of the adhesive 40 in the adhesive-bonding joint 51 and therefore a cured adhesive layer which is free of voids is achieved by virtue of the fact that the adhesive is injected into the adhesive-bonding joint 51 via a plurality of adhesive channels 50 which are distributed uniformly in the circumferential direction. As a result of the fact that the cross section of the adhesive-bonding joint is reduced in the flow direction of the liquid adhesive 40, the liquid adhesive passes particularly uniformly and without any air bubbles out of the compression space into the adhesive-bonding joint 51. A cured adhesive layer which is free of voids is therefore achieved at the adhesive-bonding point. Furthermore, the thickness of the adhesive layer increases towards the end side 12 of the bearing ring 10. Undesirable excessively high voltages at the end of the insulating tube 1 are therefore severely reduced.

As a result of the fact that an evaporator which is filled with a liquid working medium, e.g., a hydrofluoroether, is flange-connected in a vacuum-tight manner to one of the two metal armatures 2, 2′ and a condenser is flange-connected in a vacuum-tight manner to the other metal armature, a passive cooling element with a negligibly small leakage rate and a high long-term stability is achieved.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

| A | Axis |
|---|---|
| H | High-voltage insulator |
| V | Manufacturing apparatus |
| K | Force |
| 1 | Insulating tube |
| 2, 2′ | Metal armatures |
| 3 | Clamping apparatus |
| 4 | Injection aid |
| 10, 10′ | Metal armatures |
| 11 | Spacer cams |
| 12 | End side |
| 13 | Sealing face |
| 14 | Stop |
| 15 | Cavity |
| 16 | Adhesive-bonding area |
| 20, 20′ | Field electrodes |
| 21 | Adhesive-bonding area |
| 22 | Shoulder |
| 30 | Base plate |
| 31 | Spacer feet |
| 32 | Threaded rods |
| 33 | Pressure bars |
| 34 | Pressure nuts |
| 40 | Liquid adhesive |
| 41 | Compression space |
| 42 | Cylinder base |
| 43 | Piston |
| 44 | Depression |
| 45 | Closure nut |
| 46 | Plunger |
| 50 | Adhesive channels |
| 51 | Adhesive-bonding joint |
| 52 | Ventilation openings |

What is claimed is:

1. A high-voltage insulator, comprising, in a coaxial arrangement:
an insulating tube with an end in the form of a bearing ring;
a hollow metal armature held on the bearing ring;
an adhesive-bonding joint, which is provided between an adhesive-bonding area of the bearing ring and an adhesive-bonding area of the metal armature and is filled in a vacuum-tight manner with a cured adhesive layer; and
a cavity, which is extended along the axis of the insulating tube and
is radially delimited by the insulating tube and the metal armature, wherein at least one predominantly radially guided adhesive channel is arranged between the cavity and the adhesive-bonding joint, which adhesive channel is sealed with cured adhesive and has a cross section which is sufficient for guiding uncured adhesive from the cavity into the adhesive-bonding joint prior to the formation of the cured adhesive layer.

2. The insulator as claimed in claim 1, wherein the at least one adhesive channel is delimited in the circumferential direction by two axially aligned spacer cams.

3. The insulator as claimed in claim 2, wherein a plurality of spacer cams, which are arranged at a distance from one another in the circumferential direction and of which in each case two delimit one of a plurality of adhesive channels in the circumferential direction, are provided.

4. The insulator as claimed in claim 2, wherein the spacer cams are formed into an end side of the bearing ring.

5. The insulator as claimed in claim 1, wherein a cylindrical sealing face is formed into the bearing ring, which sealing face surrounds a section of the cavity which is delimited radially by the bearing ring and is extended axially between the at least one adhesive channel and a stop of the insulating tube.

6. The insulator as claimed in claim 1, wherein the adhesive-bonding joint is connected to at least one ventilation opening, which is guided predominantly radially on the outside.

7. The insulator as claimed in claim 6, wherein the cross section of the adhesive-bonding joint decreases between the at least one adhesive channel and the ventilation channel.

8. The insulator as claimed in claim 7, wherein the adhesive-bonding area of the bearing ring is conical and widens between the at least one adhesive channel and the ventilation opening.

9. A method for producing the insulator as claimed in claim 1, wherein the insulating tube and the metal armature are joined so as to form the adhesive-bonding joint and the cavity, wherein an injection aid containing liquid adhesive is installed in the cavity, and wherein the liquid adhesive is pressurized, using the injection aid, into a section of the cavity which is in the form of a compression space and is injected out of the compression space, via the at least one adhesive channel, into the adhesive-bonding joint.

10. The method as claimed in claim 9, wherein the adhesive-bonding joint is formed by the metal armature being shrunk onto the bearing ring.

11. The method as claimed in claim 9, wherein, after the installation of the injection apparatus, the insulating tube which has been joined to the metal armature is clamped in in a clamping apparatus.

12. The method as claimed in claim 9, wherein the liquid adhesive is injected, distributed in the circumferential direction, into the adhesive-bonding joint.

13. An apparatus for implementing the method as claimed in claim 9, wherein the injection aid is in the form of a piston/cylinder compression apparatus and has a compression space, which is designed to be suitable for accommodating the liquid adhesive and is delimited radially on the outside by the bearing ring and axially by a cylinder base, which is fixed in the metal armature, and a piston, which is axially displaceable in the bearing ring.

14. The apparatus as claimed in claim 13, wherein a depression for accommodating the liquid adhesive is formed into a side of the piston which delimits the compression space.

15. The apparatus as claimed in claim 14, wherein a plunger, to which pressure can be applied from the outside, rests on the side of the piston which is remote from the depression.

16. A cooling element with a high-voltage insulator as claimed in claim 1.

17. The insulator as claimed in claim 3, wherein the spacer cams are formed into an end side of the bearing ring.

18. The insulator as claimed in claim 4, wherein a cylindrical sealing face is formed into the bearing ring, which sealing face surrounds a section of the cavity which is delimited radially by the bearing ring and is extended axially between the at least one adhesive channel and a stop of the insulating tube.

19. The insulator as claimed in claim 5, wherein the adhesive-bonding joint is connected to at least one ventilation opening, which is guided predominantly radially on the outside.

20. A method for producing a high-voltage insulator, comprising, in a coaxial arrangement: an insulating tube with an end in the form of a bearing ring, a hollow metal armature held on the bearing ring, an adhesive-bonding joint, which is provided between an adhesive-bonding area of the bearing ring and an adhesive-bonding area of the metal armature and is filled in a vacuum-tight manner with a cured adhesive layer, and a cavity, which is extended along the axis of the insulating tube and is radially delimited by the insulating tube and the metal armature, the method comprising:
the insulating tube and the metal armature are joined so as to form the adhesive-bonding joint and the cavity;
an injection aid containing liquid adhesive is installed in the cavity; and
the liquid adhesive is pressurized, using the injection aid, into a section of the cavity which is in the form of a compression space and is injected out of the compression space, via the at least one adhesive channel, into the adhesive-bonding joint.

21. The method as claimed in claim 10, wherein, after the installation of the injection apparatus, the insulating tube which has been joined to the metal armature is clamped in in a clamping apparatus.

22. The method as claimed in claim 11, wherein the liquid adhesive is injected, distributed in the circumferential direction, into the adhesive-bonding joint.

23. An apparatus for implementing the method as claimed in claim 12, wherein the injection aid is in the form of a piston/cylinder compression apparatus and has a compression space, which is designed to be suitable for accommodating the liquid adhesive and is delimited radially on the outside by the bearing ring and axially by a cylinder base, which is fixed in the metal armature, and a piston, which is axially displaceable in the bearing ring.

24. A cooling element with a high-voltage insulator as claimed in claim 8.
